(19) United States
(12) Patent Application Publication
(10) Pub. No.: US 2025/0056210 A1
(43) Pub. Date: Feb. 13, 2025

(54) METHOD FOR REPORTING OR RECEIVING USER EQUIPMENT CAPABILITY, APPARATUS AND READABLE STORAGE MEDIUM

(71) Applicant: Beijing Xiaomi Mobile Software Co., Ltd., Beijing (CN)

(72) Inventors: Juan ZHANG, Beijing (CN); Shengxiang GUO, Beijing (CN)

(73) Assignee: BEIJING XIAOMI MOBILE SOFTWARE CO., LTD., Beijing (CN)

(21) Appl. No.: 18/722,332

(22) PCT Filed: Dec. 27, 2021
(86) PCT No.: PCT/CN2021/141817

§ 371 Date: Jun. 20, 2024

(51) Int. Cl. H04W 8/24; H04B 7/0413

(52) U.S. Cl. CPC H04W 8/24; H04B 7/0413

(57) ABSTRACT

A method for reporting or receiving a user equipment capability, includes: transmitting uplink signaling to a network device, where the uplink signaling includes user equipment capability indication information, which is used to indicate information related to a power level of a user equipment in multi-carrier transmission.

### CROSS-REFERENCE TO RELATED APPLICATIONS

The present application is a U.S. National Stage of International Application No. PCT/CN2021/141817, filed on Dec. 27, 2021, the contents of all of which are incorporated herein by reference in their entireties for all purposes.

### BACKGROUND OF THE INVENTION

In a wireless communication technology, multiple input multiple output (MIMO) is an antenna system that uses a plurality of antennas at both a transmitting end and a receiving end, and forms a plurality of channels between the transmitting end and the receiving end, in order to greatly improve a channel capacity.

A carrier aggregation (CA) technology improves a transmission bandwidth by means of aggregating carriers.

Carrier aggregation modes include: Mode 1, which refers to intra-band contiguous carrier aggregation, in which corresponding member carriers are located in the same band with a contiguous spectrum; Mode 2, which refers to intra-band discontiguous carrier aggregation, in which corresponding member carriers are located in the same band but with a discontiguous spectrum; and Mode 3, which refers to out-of-band discontiguous carrier aggregation, in which corresponding member carriers are located in different frequency planes with a discontiguous spectrum.

### SUMMARY OF THE INVENTION

The present disclosure provides a method for reporting or receiving a user equipment capacity, an apparatus, and a readable storage medium.

In a first aspect, the present disclosure provides a method for reporting a user equipment capability. This method is performed by a user equipment and includes: transmitting uplink signaling to a network device, where the uplink signaling includes user equipment capability indication information used to indicate information related to a power class of the user equipment in multi-carrier transmission.

In a second aspect, the present disclosure provides a method for receiving a user equipment capability. This method is performed by a user equipment and includes: receiving uplink signaling transmitted by a user equipment, where the uplink signaling includes user equipment capability indication information used to indicate information related to a power class of the user equipment in multi-carrier transmission.

In a third aspect, a communication apparatus is provided. The communication apparatus includes a processor and a memory, where the memory is configured to store a computer program; and the processor is configured to execute the computer program to implement the first aspect or any of possible designs of the first aspect.

In a fourth aspect, a communication apparatus is provided. The communication apparatus includes a processor and a memory, where the memory is configured to store a computer program; and the processor is configured to execute the computer program to implement the second aspect or any of possible designs of the second aspect.

In a fifth aspect, a computer-readable storage medium is provided. The computer-readable storage medium stores an instruction (or referred to as a computer program, or a program), where when the instruction is called and executed on a computer, causes the computer to perform the first aspect or any of possible designs of the first aspect.

In a sixth aspect, a computer-readable storage medium is provided. The computer-readable storage medium stores an instruction (or referred to as a computer program, or a program), where when the instruction is called and executed on a computer, causes the computer to perform the second aspect or any of possible designs of the second aspect.

### BRIEF DESCRIPTION OF DRAWINGS

The accompanying drawings illustrated here are used to provide a further understanding of the embodiments of the present disclosure, and constitute a part of the present application. The illustrative examples and their explanations of the examples of the present disclosure are used to explain the embodiments of the present disclosure, and do not constitute an improper limitation on the embodiments of the present disclosure.

The drawings here, which are incorporated in the description and constitute a part of the description, illustrate embodiments consistent with the embodiments of the present disclosure, and together with the description, serve to explain the principles of the embodiments of the present disclosure.

FIG. 1 is a schematic diagram of an architecture of a wireless communication system provided by an embodiment of the present disclosure.

FIG. 2 is a flowchart of a method for reporting a user equipment capability, illustrated according to an illustrative example.

FIG. 3 is a flowchart of a method for reporting a user equipment capability, illustrated according to an illustrative example.

FIG. 4 is a flowchart of a method for reporting a user equipment capability, illustrated according to an illustrative example.

FIG. 5 is a flowchart of a method for reporting a user equipment capability, illustrated according to an illustrative example

FIG. 6 is a flowchart of a method for reporting a user equipment capability, illustrated according to an illustrative example.

FIG. 7 is a flowchart of a method for reporting a user equipment capability, illustrated according to an illustrative example.

FIG. 8 is a flowchart of a method for reporting a user equipment capability, illustrated according to an illustrative example.

FIG. 9 is a structural diagram of an apparatus for reporting a user equipment capability, illustrated according to an illustrative example.

FIG. 10 is a structural diagram of an apparatus for reporting a user equipment capability, illustrated according to an illustrative example.

FIG. 11 is a structural diagram of an apparatus for reporting a user equipment capability, illustrated according to an illustrative example.

FIG. 12 is a structural diagram of an apparatus for receiving a user equipment capability, illustrated according to an illustrative example.

FIG. 13 is a structural diagram of an apparatus for receiving a user equipment capability, illustrated according to an illustrative example.

### DETAILED DESCRIPTION OF THE INVENTION

The embodiments of the present disclosure are further illustrated now in conjunction with the drawings and specific implementations.

The illustrative examples will be described in detail here, and examples thereof are shown in the drawings. When the following description refers to the drawings, unless otherwise indicated, the same numerals in different drawings indicate the same or similar elements. The implementations described in the following illustrative examples do not represent all implementations consistent with the embodiments of the present disclosure. On the contrary, these embodiments are simply examples of apparatuses and methods consistent with some aspects of the present disclosure, as detailed in the appended claims.

Terms used in the embodiments of the present disclosure are merely for the purpose of describing particular embodiments and are not intended to limit the embodiments of the present disclosure. The singular forms “a/an” and “the” used in the embodiments and the appended claims of the present disclosure are intended to include the plural forms as well, unless the context clearly indicates otherwise. It should also be understood that the term “and/or” used herein refers to and includes any and all combinations of one or more related listed items.

It is to be understood that, although the terms first, second, third, etc. may be used to describe various information in the embodiments of the present disclosure, the information should not be limited to these terms. These terms are merely used to distinguish information of the same type from each other. For example, “first information” may also be referred to as “second information” without departing from the scope of the embodiments of the present disclosure. Similarly, “second information” may also be referred to as “first information”. Depending on the context, the words “in case of” and “if” as used here may be interpreted as “in the event of . . . ” or “when . . . ” or “in response to determining”.

A description will be made in detail to the embodiments of the present disclosure, examples of which are illustrated in the drawings. Reference numerals which are the same or similar throughout the drawings represent the same or similar elements. The embodiments described below with reference to the drawings are illustrative, and are intended to explain the present disclosure, rather than being construed as limitations to the present disclosure.

The present disclosure relates to the technical field of wireless communication, and more particularly, to a method for reporting or receiving a user equipment capability, an apparatus, and a readable storage medium.

Different user equipment may support different transmitting power classes, i.e., corresponding power amplifiers (PAs) have different rated powers.

For example: the transmitting power class of Power Class 3, abbreviated as PC3, corresponds to 23 dBm. The transmitting power class of Power Class 2, abbreviated as PC2, corresponds to 26 dBm.

Some user equipment may support both an uplink (UL) multiple input multiple output (MIMO) technology and an intra-band contiguous uplink (UL) carrier aggregation (CA) technology. In addition to supporting the transmitting power class of PC3, this feature may also be used to support transmitting power classes of high power (e.g., PC2).

When a user equipment supports UL MIMO in a single-carrier mode, its power class is reported through IE ue-PowerClass.

When the user equipment supports UL MIMO in a multi-carrier mode, its power class is reported through IE PowerClass.

If the power classes reported by the user equipment through IE ue-PowerClass and IE PowerClass are inconsistent, the power class carried by IE ue-PowerClass shall prevail, that is, the power class in IE ue-PowerClass will override the power class reported by IE PowerClass.

When the user equipment supports both uplink MIMO and intra-band contiguous uplink carrier aggregation, the number of layers of supported UL MIMO is reported through IE maxNumberMIMO-LayersCB-PUSCH, and when the user equipment supports transmit diversity (TxD), supporting the TxD is reported through IE Tx txDiversity-r16.

However, in some application scenarios, the specific capabilities of the user equipment cannot be distinguished based on the current signaling.

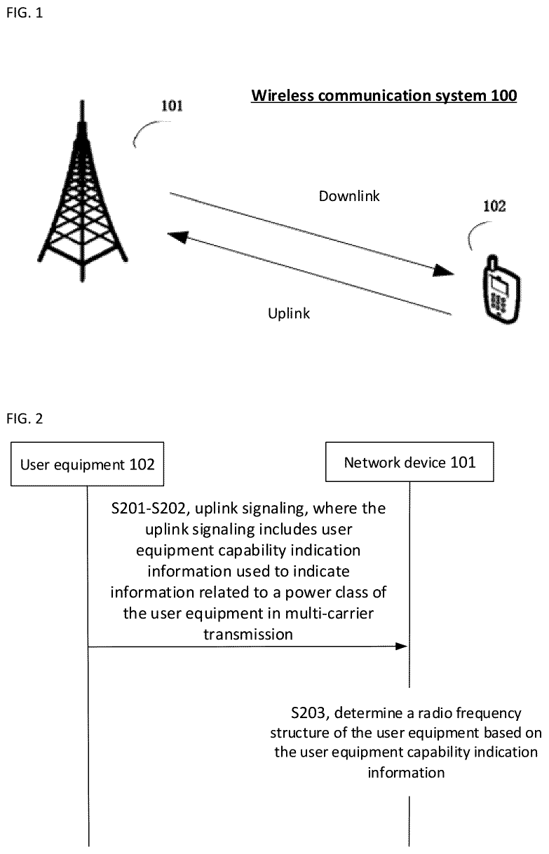

As shown in FIG. 1, a method for reporting or receiving a user equipment capability provided by an embodiment of the present disclosure may be applied to a wireless communication system 100. The wireless communication system 100 may include but is not limited to a network device 101 and a user equipment 102. The user equipment 102 is configured to support carrier aggregation. The user equipment 102 may be connected to a plurality of carrier units of the network device 101, including a primary carrier unit and one or more secondary carrier units.

It should be understood that the wireless communication system 100 may be applicable to both a low-frequency scenario and a high-frequency scenario. The application scenarios of the wireless communication system 100 include but are not limited to a long-term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-Generation (5G) system, a new radio (NR) communication system, or a future evolved public land mobile network (PLMN) system, etc.

The user equipment 102 described herein may be a user equipment (UE), a terminal, an access terminal, a terminal unit, a terminal station, a mobile station (MS), a remote station, a remote terminal, a mobile terminal, a wireless communication device, a terminal agent, or a user equipment, etc. The user equipment 102 may have a wireless transceiving function, capable of communicating (e.g., wirelessly) with one or more network devices 101 of one or more communication systems and accepting network services provided by the network device 101. The network device 101 here includes but is not limited to a base station as illustrated.

The user equipment 102 may be a cellular phone, a cordless phone, a session initiation protocol (SIP) phone, a wireless local loop (WLL) station, a personal digital assistant (PDA) device, a handheld device with a wireless communication function, a computing device, or other processing device connected to a wireless modem, a vehicle-mounted device, a wearable device, a user equipment in a future 5G network, a user equipment in a future evolved PLMN, etc.

The network device 101 may be an access network device (or referred to as an access network site). The access network device refers to a device that provides a network access function, such as a radio access network (RAN) base station. The network device 101 may specifically include a base station (BS) device, or include a base station device and a wireless resource management device configured to control the base station device. The network device 101 may further include a relay station (a relay device), an access point, as well as a base station in a future 5G network, a base station in a future evolved PLMN network, or an NR base station. The network device 101 may be a wearable or vehicle-mounted device. The network device 101 may also be a communication chip with a communication module.

For example, the network device 101 includes but is not limited to: a next-generation base station (gnodeB, gNB) in 5G, an evolved node B (eNB) in an LTE system, a radio network controller (RNC), a node B (NB) in a WCDMA system, a wireless controller under a CRAN system, a base station controller (BSC), a base transceiver station (BTS) in a GSM system or CDMA system, a home base station (e.g., home evolved nodeB, or home node B, HNB), a baseband unit (BBU), a transmitting and receiving point (TRP), a transmitting point (TP) or a mobile switching center, etc.

In a possible implementation, when the user equipment supports both uplink MIMO and intra-band contiguous uplink CA, capability reporting is performed based on the Table 1, and a user equipment with a power class of PC2 and an intra-band UL CA type of “2 PC3 PA+1LO” is allowed merely. LO refers to a local oscillator (LO).

TABLE 1

| Arch | intra-band C UL CA | UL MIMO |
|---|---|---|
| #1 | 2 PC3 PA + 1LO | PC3 |
| #2 | 2 PC3 PA + 1LO | PC2 |
| #3 | 2 PC2 PA + 1LO | PC2 |
| #4 | PC3 PA + PC2 PA + 1LO | PC2 |

Therefore, the user equipment corresponding to #2 in Table 1 may merely report TxD.

When the network device receives the following reporting from the user equipment: the number of layers of supported UL MIMO is reported as 2 (e.g., a value of 2 reported through IE maxNumberMIMO-LayersCB-PUSCH). Since the purpose of the present disclosure is to support both UL CA and UL MIMO on a terminal, it is necessary to report the number of layers of supported UL MIMO first. On this basis, a power class of a multi-carrier system is reported.

The power class of the multi-carrier system is reported as PC2 (e.g., a value of 2 reported through IE maxNumberMIMO-LayersCB-PUSCH); supporting TxD is reported (e.g., supporting TxD is reported through IE Tx txDiversity-r16); and according to Table 1, an implementation structure of the user equipment is determined as 2 PC3PA+1LO corresponding to #2.

However, when the number of layers of supported UL MIMO reported by the network device as received by the user equipment is 2, and the power class of the multi-carrier system is reported as PC2, but supporting TxD is not reported, PA corresponding to at least one PC2 in the implementation structure of the user equipment can be merely identified. According to Table 1, it is merely possible to determine that the PA may correspond to “2 PC2 PA+1LO” in #3 or “PC3+PC2+1LO” in #4, but it is not possible to determine accurately which of the two corresponds to the PA. Radio frequency indicators of the two structures may be different, especially for MPR, which may affect the accurate reporting of a lower limit of Pcmax when it is not possible to accurately determine which of the two corresponds to the other.

An embodiment of the present disclosure provides a method for reporting a user equipment capability. FIG. 2 is a flowchart of a method for reporting a user equipment capability, illustrated according to an illustrative example. As shown in FIG. 2, the method includes the following steps S201 to S203.

In step S201, a user equipment 102 transmits uplink signaling to a network device 101, where the uplink signaling includes user equipment capability indication information used to indicate information related to a power class of the user equipment in multi-carrier transmission.

In step S202, the network device 101 receives uplink signaling transmitted by the user equipment 102, where the uplink signaling includes user equipment capability indication information used to indicate information related to a power class of the user equipment in multi-carrier transmission.

In step S203, the network device 101 determines a radio frequency structure of the user equipment based on the user equipment capability indication information.

In some possible implementations, transmitting the uplink signaling includes transmitting first signaling, where the first signaling includes first capability indication information used to indicate a power class combination supported by the user equipment in multi-carrier transmission.

In some possible implementations, transmitting the uplink signaling includes transmitting second signaling, where the second signaling includes second capability indication information used to indicate a power class of the user equipment corresponding to each transmitting link in multi-carrier transmission.

In some possible implementations, transmitting the uplink signaling includes transmitting third signaling, where the third signaling includes third capability indication information used to indicate whether the user equipment supports transmitting links corresponding to different power classes on the current band in multi-carrier transmission.

In the embodiments of the present disclosure, the information related to the power class supported by the user equipment is reported by the user equipment, such that the network device may accurately determine a radio frequency structure of the user equipment. Thus, performing power configuration in a more accurate manner and improving the transmission efficiency of communication transmission.

An embodiment of the present disclosure provides a method for reporting a user equipment capability. FIG. 3 is a flowchart of a method for reporting a user equipment capability, illustrated according to an illustrative example. As shown in FIG. 3, the method includes the following steps S301 to S303.

In step S301, first signaling is transmitted to a network device, where the first signaling includes first capability indication information used to indicate a power class combination supported by the user equipment in multi-carrier transmission. In this embodiment, the uplink signaling is the first signaling.

In step S302, the network device receives the first signaling transmitted by the user equipment, where the first signaling includes first capability indication information used to indicate a power class combination supported by the user equipment in multi-carrier transmission.

In step S303, the network device determines a radio frequency structure of the user equipment based on the first capability indication information.

In some possible implementations, the power class combination includes at least two pieces of power class information. For example, the power class combination is a combination of PC3 and PC3, a combination of PC2 and PC2, and a combination of PC3 and PC2.

In some possible implementations, the first signaling is IE Tx-architecture.

When the user equipment supports the combination of PC3 and PC3, the first capability indication information is IE Tx-architecture ENUMERATED{PC3+PC3}.

When the user equipment supports the combination of PC2 and PC2, the first capability indication information is IE Tx-architecture ENUMERATED{PC2+PC2}.

When the user equipment supports the combination of PC3 and PC2, the first capability indication information is IE Tx-architecture ENUMERATED{PC3+PC2}.

In some possible implementations, the multi-carrier transmission is one of the followings: multi-carrier transmission based on carrier aggregation, multi-carrier transmission based on a dual connectivity (DC) technology, and multi-carrier transmission based on a multi-RAT dual connectivity (MRDC) of a multi-access system. The MRDC technology includes EN-DC or NE-DC.

In a possible example, the multi-carrier transmission is the multi-carrier transmission based on carrier aggregation, and the user equipment makes the following reporting: the number of layers of supported UL MIMO is reported as 2 (e.g., a value of 2 reported through IE maxNumberMIMO-LayersCB-PUSCH). Since the purpose of the present disclosure is to support both UL CA and UL MIMO on a terminal, it is necessary to report the number of layers of supported UL MIMO first. On this basis, a power class of a multi-carrier system is reported.

The power class of the multi-carrier system is reported as PC2 (e.g., PC2 is reported through IE ue-PowerClass and IE PowerClass); supporting TxD is not reported; and the first capability indication information, that is, the power class combination supported by the user equipment in multi-carrier transmission is reported as PC3+PC2.

The network device may thus determine the radio frequency structure of the user equipment as “PC3+PC2+1LO” in Table 1.

In the embodiments of the present disclosure, the information related to the power class supported by the user equipment (the power class combination supported by the user equipment in multi-carrier transmission) is reported by the user equipment, such that the network device may accurately determine the radio frequency structure of the user equipment. Thus, performing power configuration in a more accurate manner and improving the transmission efficiency of communication transmission.

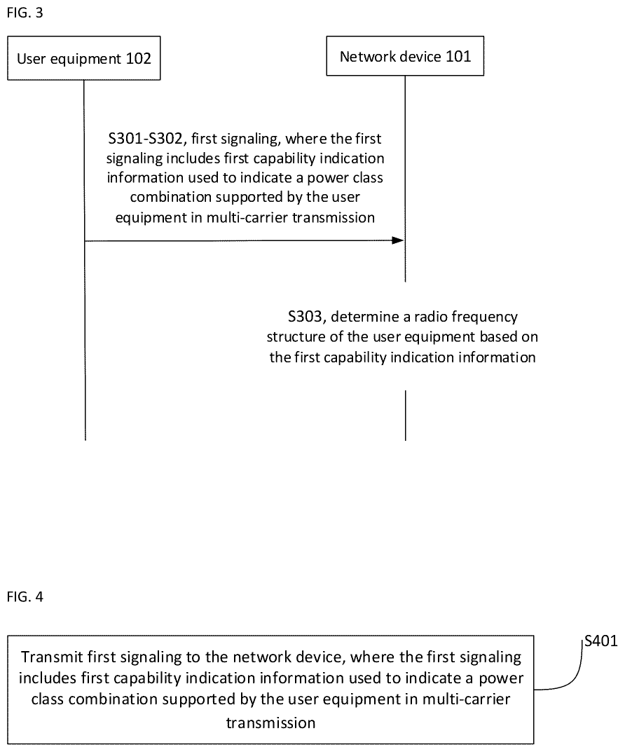

An embodiment of the present disclosure provides a method for reporting a user equipment capability. This method is performed by a user equipment. FIG. 4 is a flowchart of a method for reporting a user equipment capability, illustrated according to an illustrative example. As shown in FIG. 4, the method includes the following step S401.

In step S401, first signaling is transmitted to a network device, where the first signaling includes first capability indication information used to indicate a power class combination supported by the user equipment in multi-carrier transmission.

An embodiment of the present disclosure provides a method for reporting a user equipment capability. This method is performed by a network device. The method includes: receiving first signaling transmitted by a user equipment, where the first signaling includes first capability indication information used to indicate a power class combination supported by the user equipment in multi-carrier transmission.

An embodiment of the present disclosure provides a method for reporting a user equipment capability. This method is performed by a network device. The method includes: receiving first signaling transmitted by a user equipment; and determining a radio frequency structure of the user equipment based on the first capability indication information, where the first signaling includes first capability indication information used to indicate a power class combination supported by the user equipment in multi-carrier transmission.

An embodiment of the present disclosure provides a method for reporting a user equipment capability. FIG. 5 is a flowchart of a method for reporting a user equipment capability, illustrated according to an illustrative example. As shown in FIG. 5, the method includes the following steps S501 to S503.

In step S501, a user equipment transmits second signaling to a network device, where the second signaling includes second capability indication information used to indicate a power class of the user equipment corresponding to each transmitting link in multi-carrier transmission. In this embodiment, the uplink signaling is the second signaling.

In step S502, the network device receives the second signaling transmitted by the user equipment, where the second signaling includes second capability indication information used to indicate a power class of the user equipment corresponding to each transmitting link in multi-carrier transmission.

In step S503, the network device determines a radio frequency structure of the user equipment based on the second capability indication information.

In some possible implementations, the second capability information is determined based on the first capability information. The first capability information indicates the power class combination supported by the user equipment in multi-carrier transmission, and the second capability information determines in more detail the corresponding power class in the corresponding power class combination supported by the user equipment on each link.

In some possible implementations, the second signaling is Txi-powerClass, where i corresponds to each i transmitting link of the user equipment in multi-carrier transmission. The maximum value of i indicates the maximum number of links supported by the user equipment.

When the user equipment supports the combination of PC3 and PC3, the second capability indication information is IE Tx1-powerClass ENUMERATED {pc3} and Tx2-powerClass ENUMERATED {pc3}.

When the user equipment supports the combination of PC2 and PC2, the second capability indication information is IE Tx1-powerClass ENUMERATED {pc2} and Tx2-powerClass ENUMERATED {pc2}.

When the user equipment supports the combination of PC3 and PC2, the second capability indication information is IE Tx1-powerClass ENUMERATED {pc3} and Tx2-powerClass ENUMERATED {pc2}. Alternatively, the second capability indication information is IE Tx1-powerClass ENUMERATED {pc2} and Tx2-powerClass ENUMERATED {pc3}.

In some possible implementations, the multi-carrier transmission is one of the followings: multi-carrier transmission based on carrier aggregation, multi-carrier transmission based on a dual connectivity (DC) technology, and multi-carrier transmission based on a multi-RAT dual connectivity (MRDC) of a multi-access system. The MRDC technology includes EN-DC or NE-DC.

In a possible example, the multi-carrier transmission is the multi-carrier transmission based on carrier aggregation, and the user equipment makes the following reporting: the number of layers of supported UL MIMO is reported as 2 (e.g., a value of 2 reported through IE maxNumberMIMO-LayersCB-PUSCH). Since the purpose of the present disclosure is to support both UL CA and UL MIMO on a terminal, it is necessary to report the number of layers of supported UL MIMO first. On this basis, a power class of a multi-carrier system is reported.

The power class of the multi-carrier system is reported as PC2 (e.g., PC2 is reported through IE ue-PowerClass and IE PowerClass); supporting TxD is not reported; and the second capability indication information, i.e., the power class of the user equipment corresponding to each transmitting link in multi-carrier transmission, is reported as IE Tx1-powerClass ENUMERATED {pc3} and Tx2-powerClass ENUMERATED {pc2}.

The network device may determine the radio frequency structure of the user equipment as “PC3+PC2+1LO” in Table 1.

In the embodiments of the present disclosure, the information related to the power class supported by the user equipment (the power class of the user equipment corresponding to each transmitting link in multi-carrier transmission) is reported by the user equipment, such that the network device may accurately determine a radio frequency structure of the user equipment. Thus, performing power configuration in a more accurate manner and improving the transmission efficiency of communication transmission.

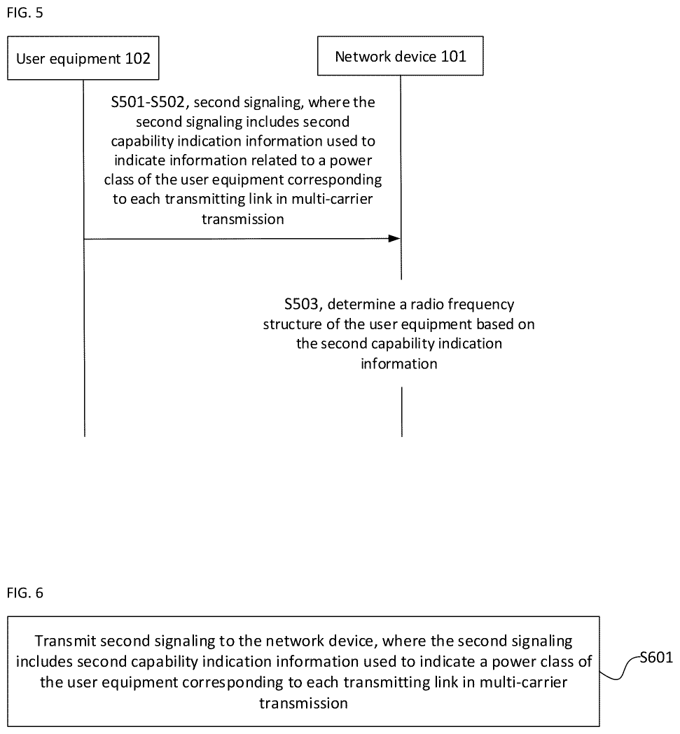

An embodiment of the present disclosure provides a method for reporting a user equipment capability. This method is performed by a user equipment. FIG. 6 is a flowchart of a method for reporting a user equipment capability, illustrated according to an illustrative example. As shown in FIG. 6, the method includes the following step S601.

In step S601, second signaling is transmitted to the network device, where the second signaling includes second capability indication information used to indicate a power class of the user equipment corresponding to each transmitting link in multi-carrier transmission. In this embodiment, the uplink signaling is the second signaling.

An embodiment of the present disclosure provides a method for reporting a user equipment capability. This method is performed by a network device. The method includes: receiving second signaling transmitted by the user equipment, where the second signaling includes second capability indication information used to indicate a power class of the user equipment corresponding to each transmitting link in multi-carrier transmission.

An embodiment of the present disclosure provides a method for reporting a user equipment capability. This method is performed by a network device. The method includes: receiving second signaling transmitted by a user equipment; and determining a radio frequency structure of the user equipment based on the second capability indication information, where the second signaling includes second capability indication information used to indicate a power class of the user equipment corresponding to each transmitting link in multi-carrier transmission.

An embodiment of the present disclosure provides a method for reporting a user equipment capability. FIG. 7 is a flowchart of a method for reporting a user equipment capability, illustrated according to an illustrative example. As shown in FIG. 7, the method includes the following steps S701 to S703.

In step S701, the user equipment transmits third signaling to the network device, where the third signaling includes third capability indication information used to indicate whether the user equipment supports transmitting links corresponding to different power classes on the current band in multi-carrier transmission. In this embodiment, the uplink signaling is the third signaling.

In step S702, the network device receives the third signaling transmitted by the user equipment, where the third signaling includes third capability indication information used to indicate whether the user equipment supports transmitting links corresponding to different power classes on the current band in multi-carrier transmission.

In step S703, the network device determines a radio frequency structure of the user equipment based on the third capability indication information.

In some possible implementations, the third signaling is diffpowerClass-tx.

When the user equipment supports the transmitting links corresponding to different power classes on the current band in multi-carrier transmission, the third capability indication information is diffpowerClass-tx ENUMERATED {supported}.

When the user equipment does not support the transmitting links corresponding to different power classes on the current band in multi-carrier transmission, the third capability indication information is default.

In some possible implementations, the multi-carrier transmission is one of the followings: multi-carrier transmission based on carrier aggregation, multi-carrier transmission based on a dual connectivity (DC) technology, and multi-carrier transmission based on a multi-RAT dual connectivity (MRDC) of a multi-access system. The MRDC technology includes EN-DC or NE-DC.

In a possible example, the multi-carrier transmission is the multi-carrier transmission based on carrier aggregation, and the user equipment makes the following reporting: the number of layers of supported UL MIMO is reported as 2 (e.g., a value of 2 reported through IE maxNumberMIMO-LayersCB-PUSCH); the power class of the multi-carrier system is reported as PC2 (e.g., PC2 is reported through IE ue-PowerClass and IE PowerClass); supporting TxD is not reported; and the third capability indication information is reported as the user equipment supporting the transmitting links corresponding to different power classes on the current band in multi-carrier transmission.

The network device may thus determine the radio frequency structure of the user equipment as “PC3+PC2+1LO” in Table 1.

In the embodiments of the present disclosure, the information related to the power class supported by the user equipment (whether the user equipment supports the transmitting links corresponding to different power classes on the current band in multi-carrier transmission) is reported by the user equipment, such that the network device may accurately determine a radio frequency structure of the user equipment. Thus, performing power configuration in a more accurate manner and improving the transmission efficiency of communication transmission.

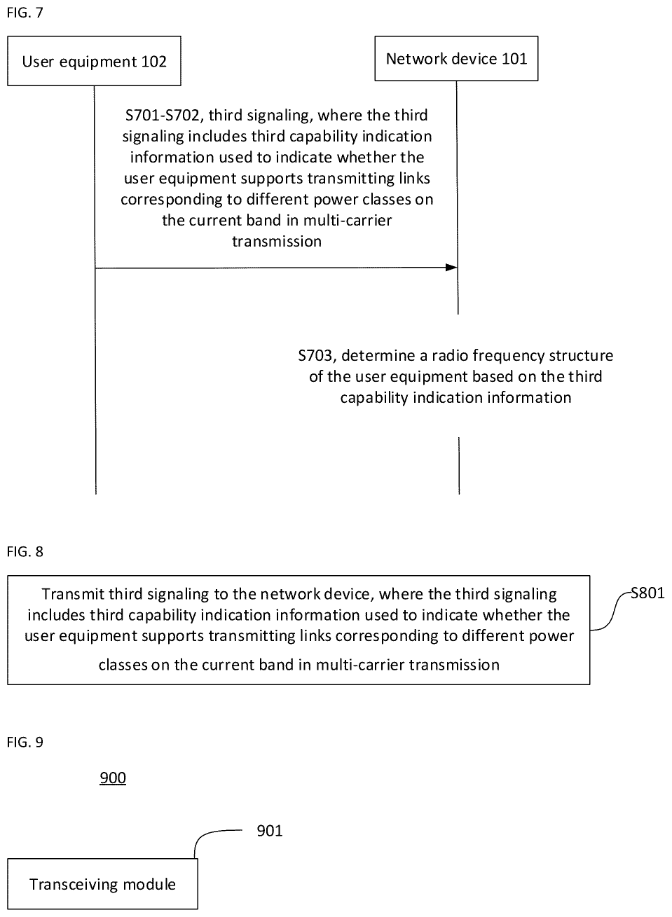

An embodiment of the present disclosure provides a method for reporting a user equipment capability. This method is performed by a user equipment. FIG. 8 is a flowchart of a method for reporting a user equipment capability, illustrated according to an illustrative example. As shown in FIG. 8, the method includes the following step S801.

In step S801, third signaling is transmitted to the network device, where the third signaling includes third capability indication information used to indicate whether the user equipment supports transmitting links corresponding to different power classes on the current band in multi-carrier transmission.

An embodiment of the present disclosure provides a method for reporting a user equipment capability. This method is performed by a network device. The method includes: receiving third signaling transmitted by a user equipment, where the third signaling includes third capability indication information used to indicate whether the user equipment supports transmitting links corresponding to different power classes on the current band in multi-carrier transmission.

An embodiment of the present disclosure provides a method for reporting a user equipment capability. This method is performed by a network device. The method includes: receiving third signaling transmitted by a user equipment; and determining a radio frequency structure of the user equipment based on the third capability indication information, where the third signaling includes third capability indication information used to indicate whether the user equipment supports transmitting links corresponding to different power classes on the current band in multi-carrier transmission.

A terminal may support both UL MIMO and intra-band contiguous uplink carrier aggregation. In addition to supporting a transmitting power class of PC3, this feature may also be used to support a transmitting power class of a high-power terminal such as PC2. The following Table 2 describes the possible implementation of the corresponding terminal.

TABLE 2

| Arch | intra-band C UL CA | UL MIMO |
|---|---|---|
| #1 | 2 PC3 PA + 1LO | PC3 |
| #2 | 2 PC3 PA + 1LO | PC2 |
| #3 | 2 PC2 PA + 1LO | PC2 |
| #4 | PC3 PA + PC2 PA + 1LO | PC2 |

When the terminal operates in a single-carrier mode, its transmitting power class is reported through IE ue-PowerClass signaling per UE. A specific signaling reporting path is UE-NR-Capability->RF-Parameters->supportedBandListNR->ue-PowerClass: ENUMERATED {pc1, pc2, pc3, pc4}. PC3 is a default power class supported by the terminal.

When the terminal operates in a multi-carrier mode, that is, if the terminal has a plurality of serving cells in this band, or also has serving cells in other bands, the transmitting power class of a total transmitting power of the terminal in all serving cells is reported through IE PowerClass signaling per band combination per UE. A specific signaling reporting path is UE-NR-Capability->RF-Parameters->supportedBandCombinationList->powerClass-v1530: ENUMERATED {pc2}/powerClass-v1610: ENUMERATED {pc1dot5}. PC3 is a default power class supported by the terminal. If the power classes reported through IE ue-PowerClass and IE PowerClass are inconsistent, the power class reported through IE PowerClass will override the power class reported through IE ue-PowerClass.

In addition, the number of layers of UL MIMO supported by the terminal is reported through IE FeatureSetDownlinkPerCC. A specific signaling reporting path is UE-NR-Capability->FeatureSets->FeatureSetUplinkPerCC->maxNumberMIMO-LayersCB-PUSCH: MIMO-LayersUL/maxNumberMIMO-LayersNonCB-PUSCH: MIMO-LayersUL. In addition, the reporting of UL MIMO capability in this path is not associated with the reporting of any power class.

Therefore, when the terminal supports UL MIMO in a single-carrier mode, its power class is reported through IE ue-PowerClass. If the terminal supports UL MIMO in a multi-carrier system, its power class is reported through IE PowerClass. If the power classes reported through IE ue-PowerClass and IE PowerClass are inconsistent, the power class reported through IE PowerClass will override the power class reported through IE ue-PowerClass.

When the terminal supports both UL MIMO and intra-band contiguous uplink carrier aggregation, supporting two layers of UL MIMO is reported through IE maxNumberMIMO-LayersCB-PUSCH=2, and supporting PC2 is reported through IE ue-PowerClass and IE PowerClass, the terminal may adopt three different implementation methods, such as 2 PC3 PA+1LO, 2 PC2 PA+1LO, and 1×23 dBm PA+1×26 dBm PA+1LO. In addition, different implementation structures need to meet different radio frequency indicators, and the corresponding power control is also different. However, it is not possible to accurately distinguish the implementation methods of the terminal based on the current signaling.

Currently, TxD can be reported merely when the terminal of PC2 supports 2 PC3 PA+1LO and the terminal of PC1.5 supports 2 PC2 PA+1LO.

Therefore, when the terminal reports supporting two layers of UL MIMO through IE maxNumberMIMO-LayersCB-PUSCH=2, supporting PC2 through IE ue-PowerClass and IE PowerClass, and supporting TxD through IE Tx txDiversity-r16, an implementation structure of the terminal can be identified as 2 PC3 PA+1LO.

When the terminal reports supporting two layers of UL MIMO through IE maxNumberMIMO-LayersCB-PUSCH=2 and supporting PC2 through IE ue-PowerClass and IE PowerClass, but does not report supporting TxD, at least one 26 dBm PA, that is, 2 PC2 PA+1LO, 1×23 dBm PA+1×26 dBm PA+1LO, in the implementation structure of the terminal can be merely identified, but 2 PC2 PA+1LO and 1×23 dBm PA+1×26 dBm PA+1LO cannot be further distinguished. However, the radio frequency indicators of the two structures may be different, especially for MPR, which will affect a lower limit of Pcmax.

When the terminal supports both UL MIMO and intra-band contiguous uplink carrier aggregation, the existing signaling of the high-power terminal cannot indicate different implementation structures of the terminal. Since different implementation structures need to meet different radio frequency indicators, a limit value of the power configuration cannot be accurately reported, especially when the terminal of PC2 supporting both 2 PC2 PA+1LO and 1×23 dBm PA+1×26 dBm PA+1LO can also report supporting TxD.

The present invention mainly solves the problem of how to distinguish different implementation structures so as to facilitate the application of corresponding radio frequency indicators when the high-power terminal supports both UL MIMO and intra-band contiguous uplink carrier aggregation.

Therefore, the following scheme is provided.

Method 1: a new signaling indicating a power class combination supported by a terminal is introduced in a multi-carrier system, for example, IE Tx-architecture ENUMERATED {pc3+pc3, pc2+pc2, pc3+pc2, . . . }.

Method 2: a new signaling indicating a power class of each transmitting link supported by terminal is introduced in the multi-carrier system, for example: IE Tx1-powerClass ENUMERATED {pc1, pc1.5, pc2, pc3, pc4, pc5} and Tx2-powerClass ENUMERATED {pc1, pc1.5, pc2, pc3, pc4, pc5}.

Method 3: based on a power class of each band supported in the multi-carrier system, e.g., ue-PowerClass-CA-r17 ENUMERATED{pc1, pc1.5, pc2, pc3, pc4, pc5}, a signaling indicating whether a terminal supports a transmitting link diffpowerClass-tx ENUMERATED {supported} of a different power class on this band is introduced.

On the basis of the same concept as the included method embodiments, an embodiment of the present disclosure further provides a communication apparatus. The communication apparatus may possess functions of the user equipment 102 in the method embodiments and be configured to perform the steps performed by the user equipment 102 provided in the included embodiments. The functions may be implemented by hardware, or implemented by performing corresponding software with software or hardware. The hardware or software includes one or more modules corresponding to the described functions.

In a possible implementation, a communication apparatus 900 as shown in FIG. 9 may serve as the user equipment 102 involved in the any of the method embodiments to perform the steps performed by the user equipment 102 in the method embodiments described herein.

The communication apparatus 900 includes: a transceiving module 901, configured to transmit uplink signaling to a network device, where the uplink signaling includes user equipment capability indication information used to indicate information related to a power class of the user equipment in multi-carrier transmission.

In a possible implementation, the uplink signaling includes first signaling. The transceiving module 901 is configured to transmit the first signaling to the network device, where the first signaling includes first capability indication information used to indicate a power class combination supported by the user equipment in multi-carrier transmission.

In a possible example, the power class combination includes at least two pieces of power class information.

In a possible implementation, the uplink signaling is second signaling. A communication apparatus 900 as shown in FIG. 9 may serve as the user equipment 102 involved in the included method embodiments to perform the steps performed by the user equipment 102 in the method embodiments described herein.

The communication apparatus 900 includes a transceiving module 901, configured to transmit the second signaling to the network device, where the second signaling includes second capability indication information used to indicate a power class of the user equipment corresponding to each transmitting link in multi-carrier transmission.

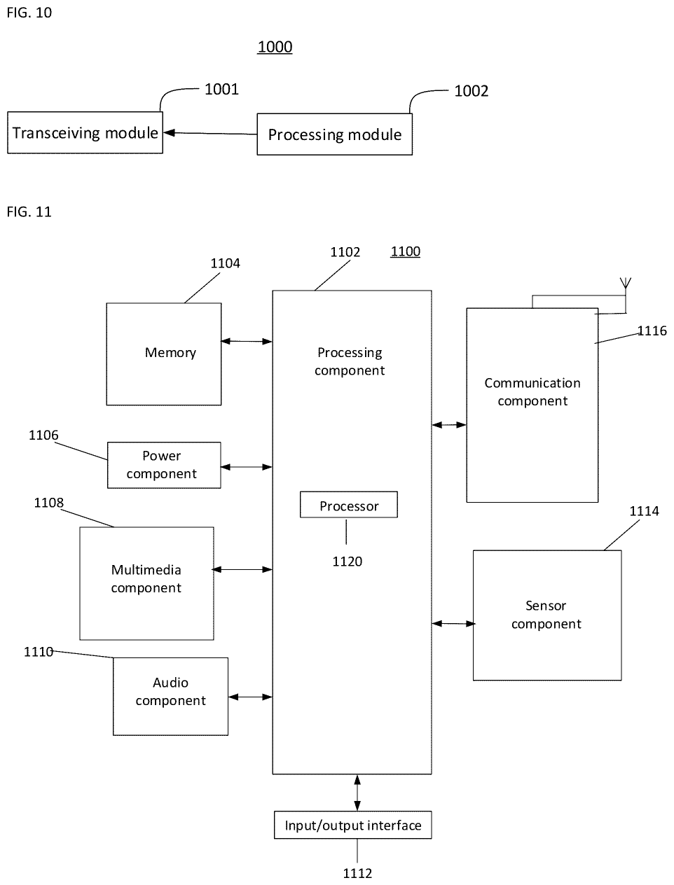

In a possible implementation, the uplink signaling is third signaling. A communication apparatus 1000 as shown in FIG. 10 may serve as a user equipment 102 involved in the any of the method embodiments to perform the steps performed by the user equipment 102 in the method embodiments described herein.

The communication apparatus 1000 includes a transceiving module 1001 and a processing module 1002.

The transceiving module 1001, configured to transmit the third signaling to the network device, where the third signaling includes third capability indication information used to indicate whether the user equipment supports transmitting links corresponding to different power classes on the current band in multi-carrier transmission; and

The processing module 1002, configured to determine, based on power classes corresponding to respective bands in multi-carrier transmission, whether the user equipment supports transmitting links corresponding to different power classes on the current band in multi-carrier transmission.

In the case that the communication apparatus is the user equipment, its structure may also be shown in FIG. 11.

FIG. 11 is a block diagram of an apparatus 1100 for reporting a user equipment capability, illustrated according to an illustrative example. For example, the apparatus 1100 may be a mobile phone, a computer, a digital broadcast terminal, a message transceiver device, a game console, a tablet device, a medical device, a fitness device, a personal digital assistant, or the like.

Referring to FIG. 11, the apparatus 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the control apparatus 1100, such as the operations associated with display, telephone calls, data communications, camera operations, and recording operations. The processing component 1102 may include one or more processors 1120 to execute instructions to complete all or part of the steps of the method described herein. In addition, the processing component 1102 may include one or more modules to facilitate interaction between the processing component 1102 and other components. For instance, the processing component 1102 may include a multimedia module to facilitate the interaction between the multimedia component 1108 and the processing component 1102.

The memory 1104 is configured to store various types of data to support operations on the apparatus 1100. Examples of such data include instructions for any applications or methods operated on the apparatus 1100, contact data, phonebook data, messages, pictures, video, etc. The memory 1104 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the apparatus 1100. The power component 1106 may include a power management system, one or more power sources, and any other components associated with the generation, management, and distribution of power for the apparatus 1100.

The multimedia component 1108 includes a screen providing an output interface between the apparatus 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, swipe, and gestures on the touch panel. The touch sensors may not only sense a boundary of a touch or swipe action, but also detect a duration and a pressure associated with the touch or swipe action. In some embodiments, the multimedia component 1108 includes a front camera and/or a rear camera. The front camera and/or the rear camera may receive external multimedia data while the apparatus 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (“MIC”) configured to receive an external audio signal when the apparatus 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel and buttons. The buttons may include but are not limited to a home button, a volume button, a starting button, and a locking button.

The sensor component 1114 includes one or more sensors that are configured to provide status assessments in various aspects for the apparatus 1100. For instance, the sensor component 1114 may detect an open/closed status of the apparatus 1100, relative positioning of components, e.g., the display and the keypad of the apparatus 1100. The sensor component 1114 may also detect a change in position of the apparatus 1100 or a component of the apparatus 1100, a presence or absence of user contact with the apparatus 1100, an orientation or an acceleration/deceleration of the apparatus 1100, and a change in temperature of the apparatus 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may further include an accelerometer sensor, a gyroscope sensor, a magnetic sensor, a pressure sensor, or a temperature sensor.

The communication component 1116 is configured to facilitate wired or wirelessly communication between the apparatus 1100 and other devices. The apparatus 1100 may access a wireless network based on a communication standard, such as WiFi, 4G, or 5G, or a combination thereof. In an illustrative example, the communication component 1116 receives a broadcast signal or broadcast associated information from an external broadcast management system via a broadcast channel. In an illustrative example, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an illustrative example, the apparatus 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the included methods.

In an illustrative example, a non-transitory computer-readable storage medium including instructions is also provided, such as a memory 1104 including instructions, which may be executed by a processor 1120 of the apparatus 1100 to accomplish the described methods. For example, the non-transitory computer-readable storage medium may be an ROM, a random access memory (RAM), a compact disc read-only memory (CD-ROM), a magnetic tape, a floppy disk, an optical data storage device, etc.

On the basis of the same concept as the method embodiments described herein, an embodiment of the present disclosure further provides a communication apparatus. The communication apparatus may possess functions of the network device 101 in the included method embodiments and be configured to perform the steps performed by the network device 101 provided in the embodiments. The functions may be implemented by hardware, or implemented by performing corresponding software with software or hardware. This hardware or software includes one or more modules corresponding to the described functions.

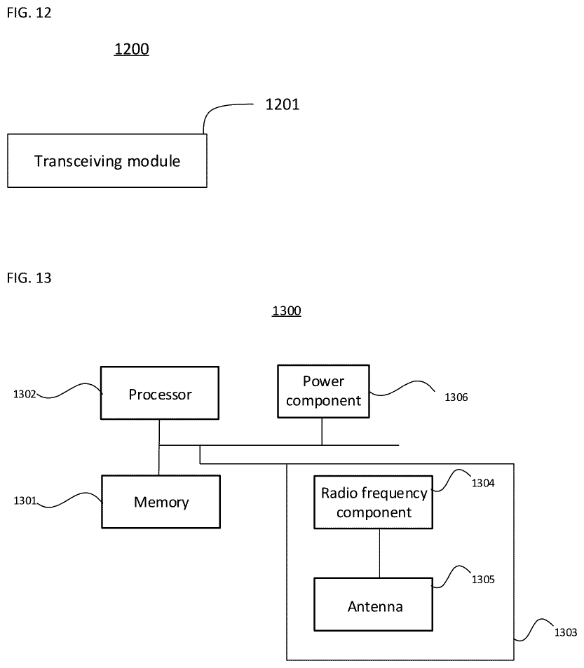

In a possible implementation, a communication apparatus 1200 as shown in FIG. 12 may serve as a network device 101 involved in the described method embodiments to perform the steps performed by the network device 101 in the included method embodiments.

The communication apparatus 1200 includes a transceiving module 1201, configured to receive uplink signaling transmitted by a user equipment, where the uplink signaling includes user equipment capability indication information used to indicate information related to a power class of the user equipment in multi-carrier transmission.

In a possible implementation, the uplink signaling includes first signaling, where the first signaling includes first capability indication information used to indicate a power class combination supported by the user equipment in multi-carrier transmission.

In a possible example, the power class combination includes at least two pieces of power class information.

In a possible implementation, the uplink signaling is second signaling. The transceiving module 1201 is configured to receive the second signaling transmitted by the user equipment, where the second signaling includes second capability indication information used to indicate a power class of the user equipment corresponding to each transmitting link in multi-carrier transmission.

In a possible implementation, the uplink signaling is third signaling. The transceiving module 1201 is configured to receive the third signaling transmitted by the user equipment, where the third signaling includes third capability indication information used to indicate whether the user equipment supports transmitting links corresponding to different power classes on the current band in multi-carrier transmission.

In the case that the communication apparatus is a network device, the structure of this communication apparatus may also be shown in FIG. 13. The structure of the communication apparatus is illustrated by taking the network device 101 being a base station as an example. As shown in FIG. 13, the apparatus 1300 includes a memory 1301, a processor 1302, a transceiving component 1303, and a power component 1306. The memory 1301 is coupled with the processor 1302 and may be configured to store programs and data essential for the communication apparatus 1300 to implement various functions. The processor 1302 is configured to support the communication apparatus 1300 to perform the corresponding functions in the included methods. The functions may be achieved by calling a program stored in the memory 1301. The transceiving component 1303 may be a wireless transceiver that may be configured to support the communication apparatus 1300 to receive signaling and/or data through a wireless air interface and to transmit the signaling and/or data. The transceiving component 1303 may also be called a transceiving unit or a communication unit. The transceiving component 1303 may include a radio frequency component 1304 and one or more antennas 1305, where the radio frequency component 1304 may be a remote radio unit (remote radio unit, RRU), which may be specifically used for the transmission of a radio frequency signal and the conversion between a radio frequency signal and a baseband signal. The one or more antennas 1305 may be specifically configured to carry out radiation and reception of radio frequency signals.

In the case that the communication apparatus 1300 needs to transmit data, the processor 1302 may carry out baseband processing on data to be sent, and then output a baseband signal to the radio frequency unit; and the radio frequency unit may carry out radio frequency processing on the baseband signal, and then transmit the radio frequency signal in the form of electromagnetic waves through the antenna. In the case that data is transmitted to the communication apparatus 1300, the radio frequency unit receives a radio frequency signal through the antenna, converts the radio frequency signal into a baseband signal, and outputs the baseband signal to the processor 1302; and the processor 1302 converts the baseband signal into data and processes this data.

Those skilled in the art will readily conceive other implementations of the embodiments of the present disclosure upon consideration of the specification and practice of the present disclosure here. The present application is intended to cover any variations, uses, or adaptations of the embodiments of the present disclosure. These variations, uses, or adaptations follow the general principles of the embodiments of the present disclosure and include common knowledge or customary technical means in the art which are not disclosed herein. The specification and embodiments are to be considered as illustrative merely, and the true scope and spirit of the embodiments of the present disclosure are indicated by the following claims.

It will be appreciated that the embodiments of the present disclosure are not limited to the exact construction that has been described herein and illustrated in the drawings, and that various modifications and changes can be made without departing from the scope thereof. The scope of the embodiments of the present disclosure is merely limited by the appended claims.

### INDUSTRIAL APPLICABILITY

In the embodiments of the present disclosure, detailed information on a power class supported by the user equipment is reported by the user equipment, such that the network device may accurately determine a radio frequency structure of the user equipment. Thus, performing power configuration in a more accurate manner and improving the transmission efficiency of communication transmission.

1. A method for reporting a user equipment capability, the method performed by a user equipment and comprising:
transmitting uplink signaling to a network device, wherein the uplink signaling comprises user equipment capability indication information used to indicate information related to a power class of the user equipment in multi-carrier transmission.

2. The method according to claim 1, wherein transmitting the uplink signaling to the network device comprises:
transmitting first signaling to the network device, wherein the first signaling comprises first capability indication information used to indicate a power class combination supported by the user equipment in the multi-carrier transmission.

3. The method according to claim 2, wherein:
the power class combination comprises at least two pieces of power class information.

4. The method according to claim 1, wherein transmitting the uplink signaling to the network device comprises:
transmitting second signaling to the network device, wherein the second signaling comprises second capability indication information used to indicate the power class of the user equipment corresponding to each transmitting link in the multi-carrier transmission.

5. The method according to claim 1, wherein transmitting the uplink signaling to the network device comprises:
transmitting third signaling to the network device, wherein the third signaling comprises third capability indication information used to indicate whether the user equipment supports transmitting links corresponding to different power classes on a current band in the multi-carrier transmission.

6. The method according to claim 5, wherein the method further comprises:
determining, based on the power classes corresponding to respective bands in the multi-carrier transmission, whether the user equipment supports transmitting links corresponding to the different power classes on the current band in the multi-carrier transmission.

7. A method for receiving a user equipment capability, the method performed by a network device and comprising:
receiving uplink signaling transmitted by a user equipment, wherein the uplink signaling comprises user equipment capability indication information used to indicate information related to a power class of the user equipment in multi-carrier transmission.

8. The method according to claim 7, wherein: receiving the uplink signaling transmitted by the user equipment comprises:
receiving first signaling transmitted by the user equipment, wherein the first signaling comprises first capability indication information used to indicate a power class combination supported by the user equipment in the multi-carrier transmission.

9. The method according to claim 8, wherein:
the power class combination comprises at least two pieces of power class information.

10. The method according to claim 7, wherein receiving the uplink signaling transmitted by the user equipment comprises:
receiving second signaling transmitted by the user equipment, wherein the second signaling comprises second capability indication information used to indicate the power class of the user equipment corresponding to each transmitting link in the multi-carrier transmission.

11. The method according to claim 7, wherein receiving uplink signaling transmitted by a user equipment comprises:
receiving third signaling transmitted by the user equipment, wherein the third signaling comprises third capability indication information used to indicate whether the user equipment supports transmitting links corresponding to different power classes on a current band in the multi-carrier transmission.

12. The method according to claim 11, wherein:
whether the user equipment supports the transmitting links corresponding to the different power classes on the current band in the multi-carrier transmission is determined by the user equipment based on the different power classes corresponding to respective bands in the multi-carrier transmission.

13-24. (canceled)

25. A communication apparatus, comprising one or more processors and a memory, wherein:
the memory is configured to store a computer program; and
the one or more processors are collectively configured to execute the computer program to:
transmit uplink signaling to a network device, wherein the uplink signaling comprises user equipment capability indication information used to indicate information related to a power class of the user equipment in multi-carrier transmission.

26. A communication apparatus, comprising one or more processors and a memory, wherein:
the memory is configured to store a computer program; and
the one or more processors are configured to execute the computer program to perform the method according to claim 7.

27. A non-transitory computer-readable storage medium, storing an instruction, wherein when the instruction is called and executed on a computer, causes the computer to perform the method according to claim 1.

28. A non-transitory computer-readable storage medium, storing an instruction, wherein when the instruction is called and executed on a computer, causes the computer to perform the method according to claim 7.

29. The communication apparatus according to claim 25, wherein the one or more processors are collectively configured:
transmit first signaling to the network device, wherein the first signaling comprises first capability indication information used to indicate a power class combination supported by the user equipment in the multi-carrier transmission.

30. The communication apparatus according to claim 29, wherein the power class combination comprises at least two pieces of power class information.

31. The communication apparatus according to claim 25, wherein the one or more processors are collectively configured:
transmit second signaling to the network device, wherein the second signaling comprises second capability indication information used to indicate a power class of the user equipment corresponding to each transmitting link in the multi-carrier transmission.

32. The communication apparatus according to claim 25, wherein the one or more processors are collectively configured:
transmit third signaling to the network device, wherein the third signaling comprises third capability indication information used to indicate whether the user equipment supports transmitting links corresponding to different power classes on a current band in the multi-carrier transmission.
